(19) United States
(12) Patent Application Publication
(10) Pub. No.: US 2006/0230109 A1
(43) Pub. Date: Oct. 12, 2006

(54) Mediator-based recovery mechanism for multi-agent system

(76) Inventors: Habin Lee, Ipswich (GB); John W. Shepherdson, Sudbury (GB)

Correspondence Address: NIXON & VANDERHYE, PC, 901 NORTH GLEBE ROAD, 11TH FLOOR, ARLINGTON, VA, 22203, US

(21) Appl. No.: 10/549,907

(22) PCT Filed: Mar. 3, 2004
(86) PCT No.: PCT/GB04/00903

§ 371 Date: Sep. 20, 2005

(30) Foreign Application Priority Data
Mar. 24, 2003 (GB) 03067394

(51) Int. Cl. G06F 15/16

(52) U.S. Cl. 709/205

(57) ABSTRACT

A method of recovering the status of a collaboration between a plurality of component agents in a multi-agent systems architecture, the method comprising: processing collaboration information forwarded by a mediator agent for each component agent; maintaining a collaboration processing status information record derived from the collaboration information provided by each collaborating agent to the mediator agent; and in the event that a device which affects the collaboration suffers an event which causes one or more component agents to lose its collaboration status, recovering the collaboration status using one or more of said collaboration processing status information records.

The present invention relates to a mediator-based recovery mechanism for a multi-agent system. In particular, but not exclusively, the invention relates to a recovery mechanism where a plurality of software agents are interacting on-line in a time-critical application which requires each agent to have an awareness of the latest state reached by other agents.

Fault tolerant multi-agent systems are already known in the art. For example, Staffan Hagg, “A Sentinel Approach to Fault Handling in Multi-Agent Systems,” in Proceedings of the Second Australian Workshop on Distributed Al, in conjunction with Fourth Pacific Rim International Conference on Artificial Intelligence (PRICAI' 96), Cairns, Australia, 1996, proposes an approach to fault handling in multi-agent systems in which a “Sentinel” agent monitors messages exchanged between application agents in order to detect any malicious or faulty agents. Implementing a Sentinel agent system enables a multi-agent system to become more robust by preventing inter-agent activity failures. The Sentinel agent is application dependent however and must be customised for each new application.

Mark Klein, Juan Antonio Rodriguez-Aguilar, and Chrysanthos Dellarocas, “Using Domain-Independent Exception Handling Services to Enable Robust Open Multi-Agent Systems: The Case of Agent Death,” Journal of Autonomous Agents and Multi-Agent Systems. 2001 also propose a Sentinel agent concept. Klein and et al. disclose a domain independent Sentinel agent so that once Sentinel agents are developed, they can be used to monitor any kind of application agent. In the multi-agent architecture, each application agent is bound with a Sentinel agent. The Sentinel agents also collaborate with each other to prevent any fault by continuously monitoring the states of the bound application agents. Lateef. O. Ogunleye, “The state detection of a multi-agent system,” Working Paper, Department of Computer Science, University of Saskatchewan, Canada discloses an enhanced fault tolerating multi-agent system. Ogunleye discloses a Report Card based state detection mechanism in which each agent has its own card which is updated at intervals to indicate how a particular task is being handled. The report card can also be used to detect the progress the agent is making in respect of the job it is handling. Ogunleye also describe a blackboard system which is used to hold all the information about the tasks available for agents to bid for, which enables detailed monitoring of the agent at the task level.

The above prior art provides fault tolerant mechanisms which are limited to preventing the failure of a multi-agent system rather than recovery from failure, and do not contemplate the issues to address if a multi-agent system does in fact crash and require recovery.

This issue has been addressed by other prior art which teaches the recovery in case of failure of a multi-agent system. For example, see Qiming Chen, Umeshwar Dayal, “Multi-Agent Cooperative Transactions for E-Commerce”, Proc. Fifth IFCIS Conference on Cooperative Information Systems (CoopIS'2000), 2000, Israel; Kumar, Sanjeev; Cohen, Philip R., “Towards a Fault-Tolerant Multi-Agent System Architecture”, In Proceedings of the Fourth International Conference on Autonomous Agents (Agents 2000), ACM Press, Barcelona, Spain, Jun. 3-7, 2000, pages 459-466; Kumar, Sanjeev; Cohen, Philip R.; Levesque, Hector J. “The Adaptive Agent Architecture: Achieving Fault-Tolerance Using Persistent Broker Teams”, In Proceedings of the Fourth International Conference on Multi-Agent Systems (ICMAS 2000), Boston, Mass., USA, Jul. 7-12, 2000, pages 159-166. 2000; and Pradeep R. Varakantham, Santosh K. Gangwani, and Kamalakar Karlapalem, “On Handling Component and Transaction Failures in Multi Agent Systems,” ACM SIGecom Exchanges, Vol 3.1, pp. 32-43, 2002.

In both Kumar et al. (2000) references, an Adaptive Agent Architecture is proposed which supports fault-tolerant multi-agent systems by using persistent broker teams. With this approach, a multi-agent system having a broker team can recover from a crash involving one or more broker(s) with the collaboration of the remaining broker agents. On the other hand, Chen and Dayal customise transaction management techniques in distributed database systems for multi-agent systems. For this, they introduce multi-agent co-operative transaction and peer-to-peer protocols for commit control and failure recovery.

Varakantham et al provide a recovery mechanism for a crashed multi-agent system by using workflow concepts within an agent and logging all the workflow state information into local storage. However, the solution Varakantham et al propose is suitable only for systems where a participating agent runs on a device which has sufficient local storage to ensure that agent(s) can save their interaction states to the local device periodically. The solution proposed is therefore not suitable whenever local storage is either not provided, for example, for mobile devices with little or no local storage, or where several agents require a rapid indication of the real-time status of other agents, such as might happen, for example, if a wireless connection to the Internet is lost due to battery failure whilst a user is participating in an on-line auction or gaming application.

Software systems can be modelled with a software architecture. The term software architecture refers to a high-level model of a software system with a collection of computational components and their interactions which are the connectors such as procedure calls, event broadcasts, database queries and pipes. An architectural model of a software system enables mutual communications, early design decisions, and transferable abstractions of a system to be obtained. In addition, the software architecture delineates between the components and component interactions in the system. Advantageously, the architecture makes complex systems more tractable, analysable, and reusable. (See Garlan, D. and Shaw, M., “An Introduction to Software Architecture”, International Journal of Software Engineering and Knowledge Engineering, Vol. 1, World Science Publishing, 1993, and Robbins, J. E., Medvidovic, N., Redmiles, D. F., and Rosenblum, D. S., “Integrating Architecture Description Languages with a Standard Design Method”, ICSE, Kyoto, Japan, 1998, pp. 209-218 for more information.)

Agent architecture can be classified into two categories: the internal architecture of a single agent and the architecture of a multi-agent system (MAS). In a MAS, the multi-agent architecture plays an important role in defining relationships and collaborations among agents. A MAS provides the technology to support group working through the autonomous and intelligent interactions of agents. This autonomy reduces a human worker's information overload and helps to manage the interaction with other workers.

The utility of this support is maximised when a group of human workers are involved in a long-term collaboration (for example, over timescales such as that related to auctions or contract nets). A disadvantage of using a known MAS to support a long-term group collaboration is that most stages of the collaboration are hidden to a human user, which makes it difficult to recover the collaboration states when there is any critical failure during the collaboration. As a result, if a critical failure (such as the crash of an agent) happens during a long-term agent interaction, the whole collaboration must be re-started from the beginning, resulting in loss of time and an increase in the effort involved. Furthermore, as there are multiple agents involved in a collaboration, the crash of an agent cannot be notified instantly to the other agents—other agents may hang if they do not get a response from the crashed agent for a long time.

Known solutions to such problems have limitations, including a design requirement limiting the solutions to devices that have local permanent storage. Such known solutions generally involved storing the collaboration states of an agent (using local storage), and use the stored information to recover the collaboration states of the crashed agent. This is not a viable solution where the device under consideration does not have local storage or if the agent platform does not support a caching functionality (for example, as is the case with certain variants of the Java™ virtual machine). As an example, a handheld device (for example, a mobile phone or PDA) may not have any local storage and/or agent platform caching functionality.

It is desirable, if a mobile device crashes for some reason, or suddenly is otherwise disconnected from its communication network, for example because of a flat battery, for the user of the mobile device to be able to continue their current collaborations with other agents using another mobile device whose battery is not flat. Such a simple recovery mechanism is not possible with current MAS architectures.

The invention seeks to mediate and/or obviate the above disadvantages of the prior art by providing a collaboration mediator agent which will run on any device having storage facility and record the collaboration states of other component agents in a MAS.

According to a first aspect of the invention, there is provided a method of recovering the status of a collaboration between a plurality of component agents in a multi-agent architecture, the method comprising: processing collaboration information forwarded by a mediator agent for each component agent; maintaining a collaboration processing status information record derived from the collaboration information provided by each collaborating agent to the mediator agent; and in the event that a device which affects the collaboration suffers an event which causes one or more component agents to lose its collaboration status, recovering the collaboration status using one or more of said collaboration processing status information records.

Preferably, the mediator agent registers its mediation service with an administration agent of a multi-agent platform

Preferably, the component agents subscribe to the mediation service prior to said step of recovering the collaboration status.

Preferably, in a method of the first aspect, if a first component agent delegates its role to at least one other delegate component agent, the mediator agent maintains status information on the role of at least one other delegate component agent.

Preferably, the collaboration between said plurality of agents is defined by an interaction plan comprising a global plan and a local plan, wherein the global plan specifies overall interaction steps for all component agents participating in the collaboration and the local plan specifies collaboration activities for each participating component agent.

Preferably, the collaboration information forwarded to the mediator agent comprises an execution state of a component agent's local plan.

Preferably, the component agent does not store an execution state of that component agent's local plan instance in permanent storage on the device where the agent is running.

According to a second aspect of the invention, there is provided an apparatus arranged to recover the status of a collaboration between a plurality of component agents in a multi-agent architecture, the apparatus comprising: at least one processor arranged to process collaboration information forwarded by a mediator agent for each component agent; storage means arranged to maintain a collaboration processing status information record derived from the collaboration information provided by each collaborating agent to the mediator agent; and in the event that a device which affects the collaboration suffers an event which causes one or more component agents to lose its collaboration status, means to provide information derived from said one or more of said collaboration processing status information records in a form suitable for updating each component agent affected by the event with current collaboration status information.

Advantageously, in embodiments of the invention where the apparatus comprises a mobile phone or PDA, the low weight of the device can be maintained as there is no requirement to provide storage capacity on the device to ensure recovery in the event of a crash of the MAS.

According to a third aspect of the invention, there is provided a computer program product comprising a suite of one or more computer programs arranged to implement any one of the method aspects of the invention.

According to a fourth aspect of the invention, there is provided a signal comprising a service subscription message arranged to subscribe a component message to a mediator service.

According to a fifth aspect of the invention, there is provided a network comprising a plurality of apparatus according to the second aspect of the invention, at least two apparatus being interconnected.

According to a sixth aspect of the invention, there is provided a multi-agent architecture comprising a plurality of component agents and a mediator agent, the mediator agent arranged to mediate between a plurality of said component agents performing a collaboration, the architecture being arranged to perform steps in the method according to the first aspect of the invention.

According to a seventh aspect of the invention, there is provided a method of delegating between a first component agent arranged to perform a predetermined role and another agent in a multi-agent architecture, the component agent and the other agent arranged to communicate via a mediator agent, the method comprising the steps of: sending a request message from the first component agent to a mediator agent for delegation to another agent; forwarding the delegation request message to the other agent by the mediator agent; receiving the delegation request at the other agent; processing the delegation request and providing an indication to the mediator agent that the delegation request has been accepted; transferring from the mediator agent, information comprising a local workflow case to the other agent from the first component agent.

According to an eighth aspect of the invention, there is provided a component agent arranged to provide recovery information to a mediator agent, the component agent having means to forward information indicating its local interaction plan state to a mediator agent.

According to a ninth aspect of the invention, there is provided a component agent arranged to provide recovery information to a mediator agent, the component agent having means to store information indicating its local interaction plan state and to forward information on said interaction state to a mediator agent.

According to a tenth aspect of the invention, there is provided a mediator agent arranged to implement a method of recovering the status of a collaboration between a plurality of component agents in a multi-agent systems architecture, the mediator agent comprising: means to receive and store collaboration information provided by each component agent; means to update the collaboration information to generate at least one processing status information record; and in the event that a device which affects the collaboration suffers an event which causes one or more component agents to lose its collaboration status, recovering the collaboration status using one or more of said collaboration processing status information records.

Advantageously, by providing a collaboration mediator agent that runs on a device having local storage, the collaboration states of component agents that run on devices having no local storage can be stored.

Preferably, the component agents interact with each other only through mediator agent(s).

Advantageously, as all the messages are routed by a mediator agent, the mediator agent keeps the latest collaboration state and even internal states of participating agents. If any of the component agents crashes, then the agent restarts and retrieves the latest state (both of the collaboration and internal state) before its crash from the mediator agent, in order to recover.

Advantageously, the interaction model comprising the local and global plans of the invention represents general multi-agent interaction, whereas Varakantham et al use a Petri-net model to represent only the problem solving process of a single agent and a multi-agent interaction to solve a hierarchical problem. Varakanthan recovers this type of interaction by making the multi-agent interaction similar to a single agent's behaviour.

That is, the initiator agent controls behaviour of sub-agents to solve a problem. In this approach, the super and sub-agents has a master-slave relationship, wherein a master agent has total control over its slave agents. This means once a master agent crashes, it is not possible to recover its slaves, and hence not possible to recover whole systems. This is not an approach which is suitable for peer-to-peer agent interactions such as those that occur in on-line auction, contract-net, and on-line gaming scenarios.

According to an eleventh aspect of the invention, there is provided a workflow engine architecture arranged to be embedded into a component agent, the workflow engine architecture comprising: a scheduler; a task manager; a state manager; a tool library; and a workflow case base.

According to a twelfth aspect of the invention, there is provided a method of restarting a local workflow case dynamically given by a mediator agent, the method comprising: verifying the validity of received workflow case from a mediator agent;
storing the valid workflow case into local workflow case base; and synchronising the local workflow case with global workflow case of the mediator agent by executing the buffered messages from a mediator agent.

The features of the invention as defined above or by the dependent claims may be combined in any appropriate manner with any appropriate aspects of the invention as is apparent to those skilled in the art.

Preferred embodiments of the invention will now be described with reference to the accompanying drawings which are by way of example only, in which:

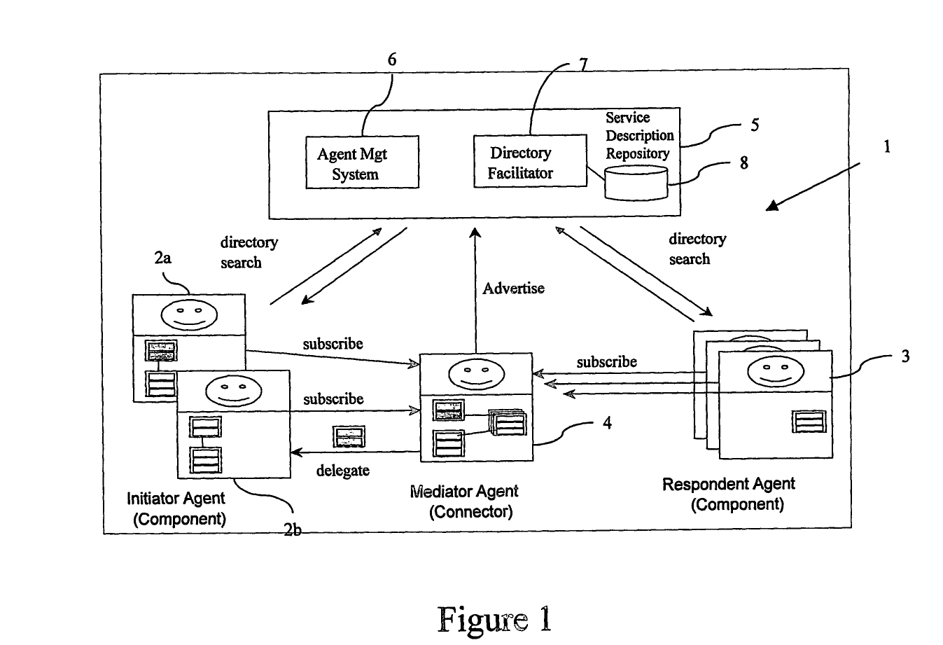

FIG. 1 is a schematic diagram of a mediator-based multi-agent architecture according to the invention;

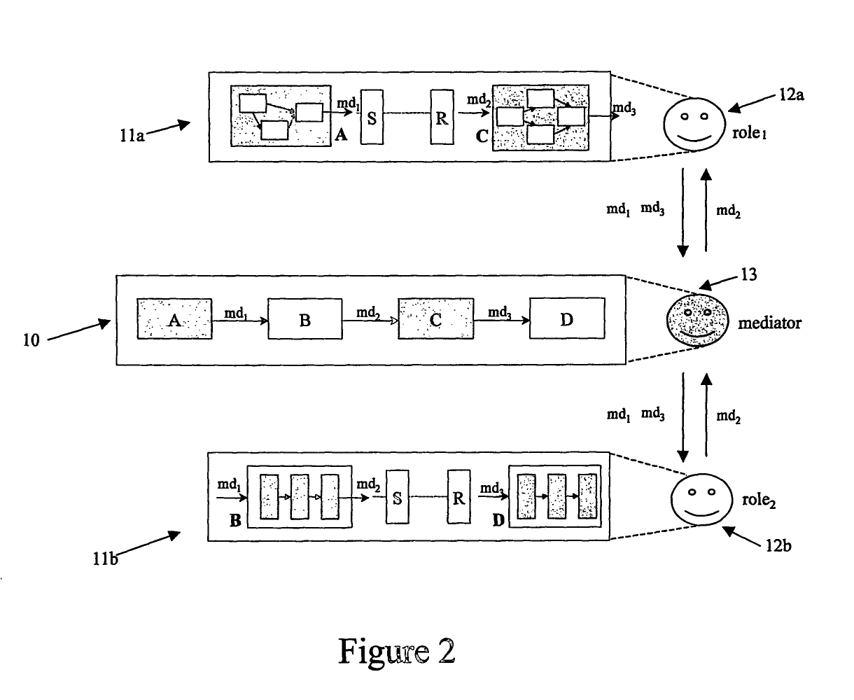

FIG. 2 is a schematic diagram of a interaction plan according to the invention;

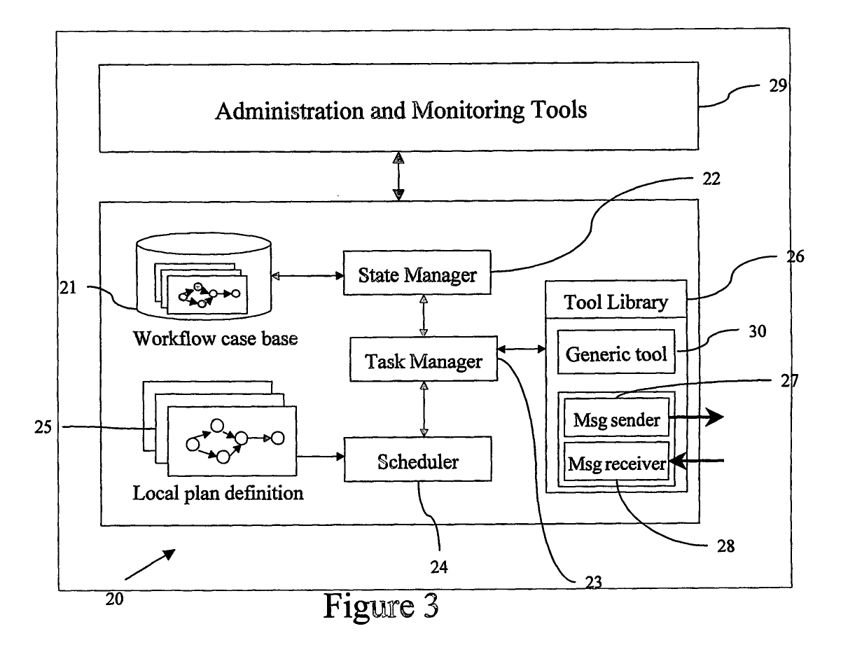

FIG. 3 shows schematically the architecture of the lightweight workflow engine;

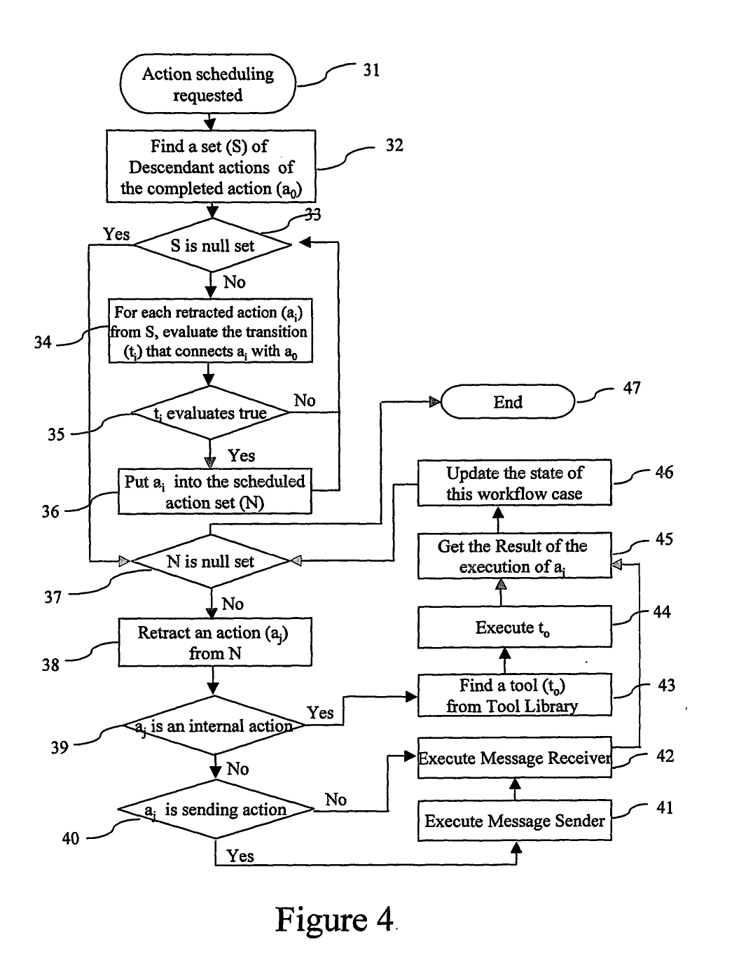

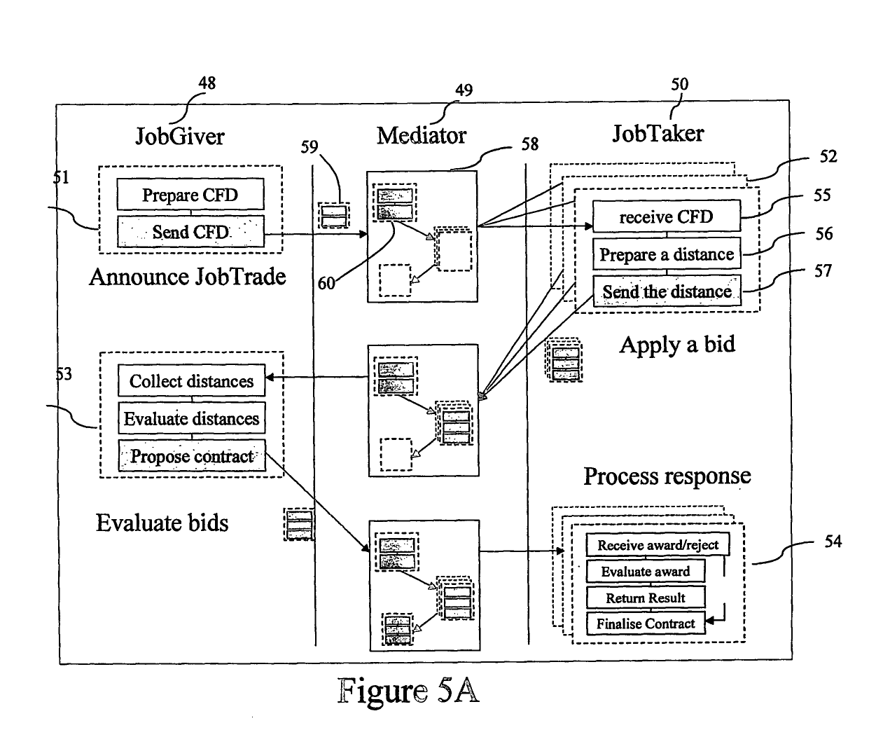

FIG. 4 shows schematically a detailed procedure to schedule and execute actions when a preceding action is completed in a local interaction plan;

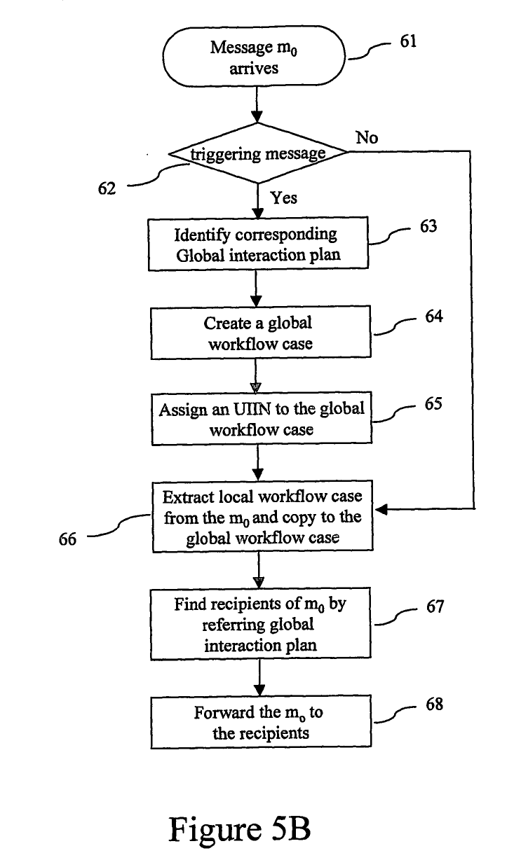

FIGS. 5A and B show schematically the global interaction case composition process for a specific multi-agent interaction;

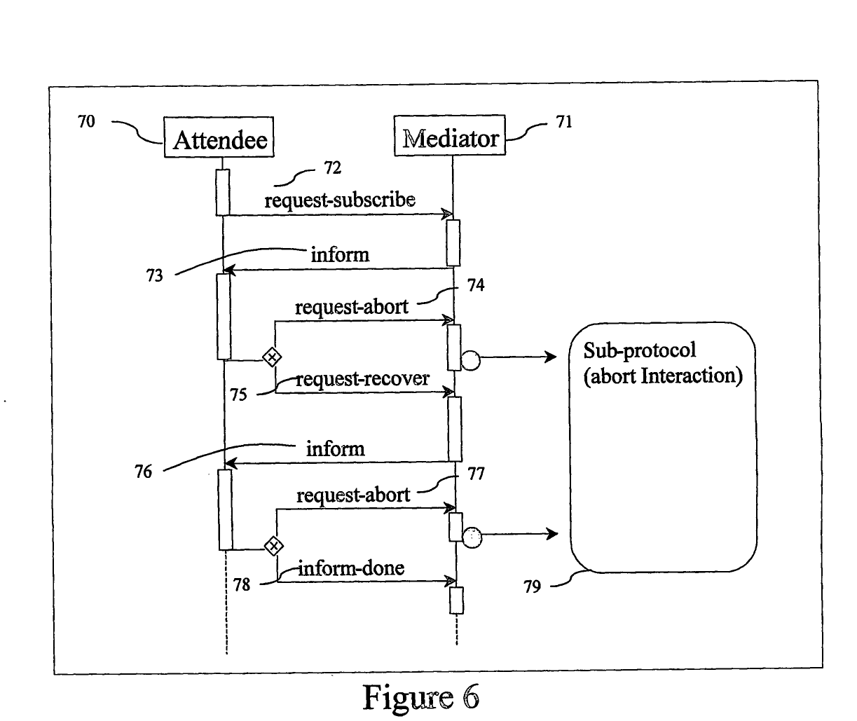

FIG. 6 shows schematically the interaction recovery protocol;

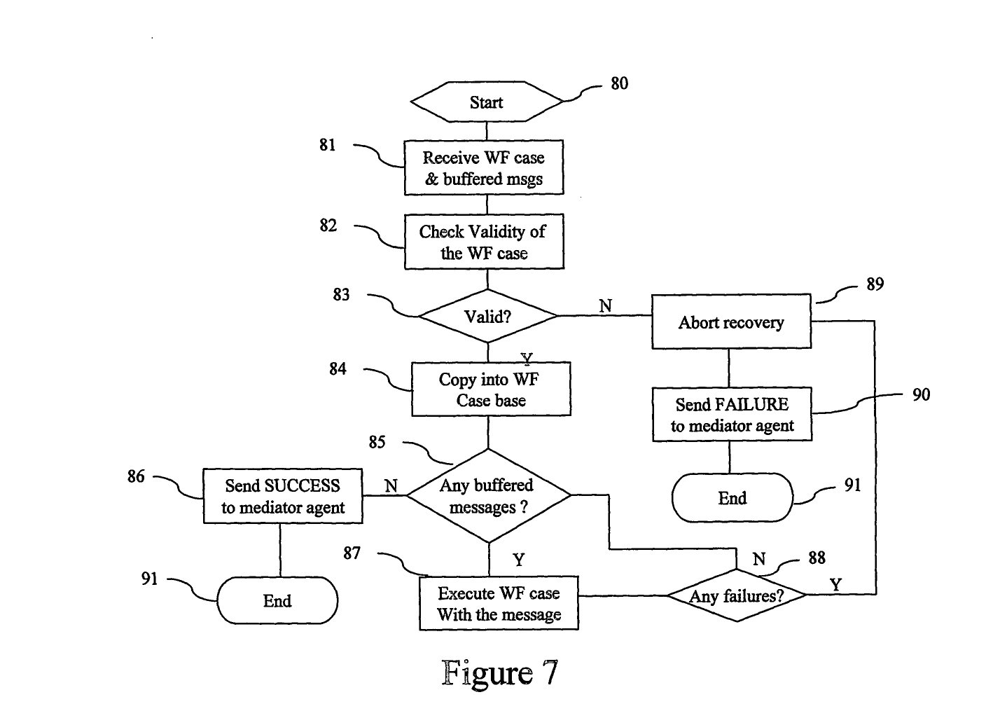

FIG. 7 shows schematically the recovery process within an agent; and

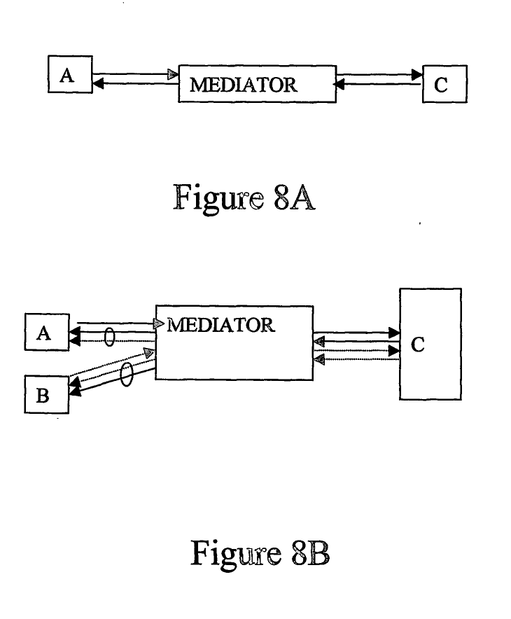

FIGS. 8A and 8B respectively show schematically the exchange of collaboration information according to two embodiments of the invention.

There follows a detailed description of the preferred embodiments of the invention, which include a description of the best mode of the invention as currently contemplated by the inventors. Even where not explicitly described, it will be apparent to those skilled in the art that certain features of the invention can be replaced by their known equivalents, and the scope of the invention is intended to encompass such equivalents where appropriate.

Referring now to FIG. 1 of the accompanying drawings, a mediator-based multi-agent system (MAS) architecture according to one embodiment of the invention is shown schematically. In FIG. 1, the architecture 1 comprises a plurality of component agents 2a, 2b, 3 and a mediator agent 4 arranged to connect each component agent 2a, 2b, 3 to each other. The mediator agent 4 is also arranged to provide input to an administration system 5 to enable each component agent to subscribe to its mediating services when seeking to collaborate with each other which is described in more detail below. Briefly, the input the mediator provides to the administration system enables the mediator to advertise its mediation service to the component agents when the component agents request a directory search from the administration system 5. For this purpose, the administration system includes an agent management system 6 and a directory facilitator 7 supporting one or more service description repositories 8

More specifically, in the embodiment of the invention shown in FIG. 1, the mediator agent registers its mediation service with the administration system by providing information to a service description repository which is maintained by an administration agent such as the directory facilitator of the FIPA specification (for more details see FIPA Abstract Architecture Specification, Foundation for Intelligent Physical Agents, 2000, http://www.flpa.org/specs/). Other advertising mechanisms may be used providing these enable the mediator agent to provide an appropriate service description. The service description of the mediator agent includes the mediation service name, interaction protocol to use, etc. The component agents get the address of the mediator agent and, if the service description conforms to certain criteria, the component agents subscribe themselves to the mediation service of the mediator agent.

The subscription based mediation service is provided by the mediator agent. To subscribe to the mediation service, a component agent sends the mediator agent a subscription message which contains the name of the mediation service and the role of the subscribing agent in the mediation service.

The internal state of each component agent 5,6 is represented by a local workflow case, which is an instance of a local interaction plan that specifies actions that should be executed by the agent to participate in a collaboration with other agents in the MAS. A collaboration state of all the collaborating agents (just two are shown in FIG. 1 for clarity) is represented by a global workflow case, which is an instance of a global interaction plan that specifies actions that should be executed by all the participating agents in the collaboration.

As FIG. 1 shows, this architecture can be used for delegation of a role from a component agent 2a to at least one other component agent 2b (described in more detail herein below) as well as the recovery of a crashed component agent. A role delegation relationship exists between two component agents if an agent delegates its role in an interaction plan to another component agent, in which case the mediator agent sends all the local workflow cases for the donor agent to the delegate agent.

The ability of the architecture to support the delegation of agent roles and to rapidly recover after a crash is useful in any situation where a mechanism to manage multi-agent interaction is required. The global and local plan interaction models of the architecture advantageously support state synchronisation and role delegation, which is particularly useful for a mobile device operator who wants to change from a mobile device to another because of e.g. a battery problem in the middle of collaboration.

In FIG. 1, the ‘collaboration mediator’ based multi-agent architecture for the recovery of multi-agent systems on devices with no localised storage facilities uses an interaction protocol that defines the order of the messages exchanged among participating agents. The mediator agent manages collaboration among the component agents according to the employed interaction protocol. That is, all the component agents send messages only to the mediator agent, then the mediator agent routes the messages to the other agents which adopt a role which is responsible for the processing of the messages in each stage. As all the messages among the component agents go through the mediator agent, the mediator agent keeps and updates the collaboration states of the component agents. In preferred embodiments of the invention, the mediator agent runs on a device having local storage so that it can log the collaboration states locally to recover from its crash. In contrast, the component agents may be running on devices which do not have local storage.

Referring now to FIG. 2 of the accompanying drawings, an interaction plan structure according to the invention is shown schematically. The interaction plan describes the workflow for an interaction protocol. The workflow comprises the detailed processes of the interaction protocol. In FIG. 2, the interaction plan structure comprises a global interaction plan 10 and local interaction plans 11a, 11b. Each participating agent in an interaction (which includes both component and mediator agents) is provided with the same understanding of the interaction protocol used for a mediation service by using interaction plans: a mediator agent 13 keeps a global interaction plan 10 and each component agent 12a, 12b keeps a local interaction plan 11a, 11b.

The global interaction plan 10 specifies overall interaction steps in which participating roles perform some activities. Each activity is described by corresponding actor role, cardinality, an input message, and an output message. Cardinality specifies whether the activity should be instantiated as multiple instances that are performed concurrently and by different actors having the same role.

A global interaction plan has a constraint that the adjacent actions should be performed by different roles. For example, the activities A and B (or C and D) in the global interaction plan 10 cannot be executed by the same agent. Interaction control is transitioned from one agent to another agent via a message. That is, activity A produces a message md₁ which is passed to another agent to be used as an input for activity B (as is the case for md₂ and md₃).

Two local interaction plans 11a, 11b for the global interaction plan 10 are shown in FIG. 2. Each local interaction plan is a detailed plan for activities defined in a global plan that belong to a role. Each activity in a global plan is detailed in terms of action (that is, an activity is a composition of one or more actions) in a local interaction plan to represent how the input message (md₁ for B, md₂ for C, and md₃ for D) is processed to create an output message (md₁ for A, md₂ for B, and md₃ for D)

In FIG. 2, component agent 12a performs role 1 in the global interaction plan 10 and is responsible for execution of activities A and C. On the other hand, component agent 12b performs role 2 in the global interaction plan 10 and is responsible for activities B and D. Each component agent 12a, 12b executes its local interaction local plan 11a, 11b respectively and sends its execution states independently to the mediator agent to be logged into the local machine where the mediator agent is running.

The adjacent activities in the global interaction plan 10 cannot be performed by one role. Accordingly, the sub activities in a local plan for a role are disconnected in some point (from the last action of the activity A(B) to the first action of the activity C(D) in FIG. 2). These are connected using special actions, “send message” and “receive message” (activity “S” and “R” in FIG. 2). When a role produces an output message, the send message action is executed to send the message to the mediator agent. And then, the control moves to “receive message” state, i.e. waits to receive the input message for the next stage.

In FIG. 2, each local interaction plan 11a, 11b is shown schematically as an ordered series of actions (represented by inner rectangles within an activity (A, B, C, or D) in FIG. 2) that are linked by transitions (represented by arrows). Each action is described with its input value, output value, tools used to execute the action, and post conditions. A transition links two adjacent actions. A transition is described with pre action, post action, and can be augmented with a condition which evaluates true or false according to each workflow instance. Execution of a local plan produces a workflow case. A workflow case contains history information regarding the execution of a local plan. The history information includes the creation time of a workflow case, the creator, finished time, and order of completed activity cases. An activity case contains the start time, completion time, executor, input value, and output value.

For example, in an auction, “Announce Auction Initiation”, “Bid Price”, “Update Highest Price”, and “Close Auction” become activities. The actions for the activity “Announce Auction Initiation” would be “Decide initial price”, “Finds participants for the auction”, and “Prepare product description” etc.

Workflow Engine Embedded Agent

Each component agent 12a, 12b is equipped with a workflow engine to schedule and execute the local interaction plans. In a preferred embodiment of the invention, the workflow engine is a lightweight workflow engine. In this specification, the term “lightweight workflow engine” refers to a workflow engine in which the workflow instances are volatile and the state information of a workflow instance is therefore not stored in permanent storage. Such workflow models do not support all the modelling constructs defined by the Workflow Management Coalition (WfMC) or, in particular, implement interfaces 4 and 5 as defined in the workflow reference architecture of the WfMC. The interfaces are not necessary in the architecture of the workflow engine according to invention. More details on WfMC can be accessed from the WfMC (Workflow management coalition), http://www.wfmc.org/ and WfMC Workflow standard specification, TC-1016-P- “Interface 1: Process Definition Interchange Process Model”, http://www.wfmc.org/standards/docs/if19807r3.pdf.

Referring now to FIG. 3 of the accompanying drawings the internal architecture of a lightweight workflow engine embedded agent according to one embodiment of the invention is shown schematically. The workflow engine 20 comprises a workflow case base 21, state manager 22, task manager 23, scheduler 24, local plan definition 25, and a tool library 26. The local plan definition is mainly referred to by scheduler 24 to determine the following actions when an action is completed by task manager 23.

FIG. 4 shows a detailed procedure to schedule and execute actions when a preceding action is completed. When the scheduler 24 (see FIG. 3) is requested to schedule next actions (step 31), it find a set of descendant actions of the precedent action (step 32). Then, the scheduler 24 evaluates the condition of the transition that connects each descendant action with its precedent action (steps 33 and 34).

Only the action linked with a transition that evaluates true is included into scheduled action set (step 36). The Scheduler 24 then informs the Task Manager 23 to execute the scheduled actions.

Task Manager 26 analyses the action definition (steps 37,38) provided by the scheduler from the local interaction plan definition 25 to find appropriate tools for the execution of the actions from the tool library 26. The action can be an internal action (application specific actions defined for an activity) or a co-ordination action (specialised actions to send/receive messages to/from a mediator agent).

If an internal action is scheduled for execution 39, then the Task Manager 23 finds an appropriate tool from the Tool Library 26 (step 43) and invokes it to get output for the action (steps 44 to 45), and the output of the previous action is used as input to the next action (step 46, leading to step 37).

If the scheduled action is not an internal action, but instead a coordination action (step 40), the action is performed by two generic tools in the tool library 26, message sender 27 and message receiver 28. For example, if the co-ordination action is a sending action (step 40), the Task Manager provides as input to the message sender 27 information comprising the current workflow case and an ACL message which is then sent to the mediator agent (step 41). The output of the message sender tool is the filtering information which is used to identify the response message from other participating agents. Then, the filtering information is used as an input of the message receiver tool 28 which, then, waits to receive any response messages from the mediator agent (step 42).

The execution result of the each tool is monitored by the Task Manager 23 which informs the State Manager 22 of the result, and the State Manager 22 updates the corresponding workflow case (step 46). The workflow case 21 is queried by Administration and Monitoring Tools 29 (such as a GUI used to show progress information to the mobile workers).

The Composition of a Global Interaction Case

FIGS. 5A, B, C show schematically the global interaction case composition process for a specific multi-agent interaction (for example, such job trading between mobile workers).

FIG. 5A shows one embodiment of the invention which relates to job-trading between two or more parties. In the embodiment shown in FIG. 5A, the roles of the parties' agents comprise: the job giver 48, mediator 49, and job taker agents 50. Job trading is a useful coordination mechanism between mobile workers, which allows a worker who has a job that can not be finished by himself/herself because of time constraints or other reasons reassign the job to his/her colleagues based on predefined policy (for example, minimise the distance from the job location to a colleague's current location) see H Lee, M Buckland, and J Shepherdson, “A multi-agent system to support location-based group decision making in mobile teams”. BT Technical Journal, Vol. 21, No. 1, 2003. A job is defined herein to comprise customer information, job details such as equipment repair or provision etc., and job importance etc. The overall process of the job trading is performed in following steps:

First, a job giver sends one or more C0FD (call for distance) messages. Each message includes the details of the job the job giver wants to trade and is sent to appropriate candidates to inform the prospective candidates that the job-giver seeks a job trade. The candidates then select an appropriate application for responding to the CFD.

A CFD message recipient wants to be allocated the job, the distance from the message recipient's current location to the job location is calculated. This distance value can be used to create bids that contain the calculated distance to send to the job giver. Next, the job giver evaluates the received bids and select the most appropriate bidder using appropriate one or more appropriate criteria (generally related to the closest worker to the job). A message containing an indication of the result is sent back to the job bidders to inform the job bidder if his/her bid has been accepted or rejected.

In this embodiment, the global interaction plan of the MAS agent interaction consists of four activities, Announce job trade 51, Apply a bid 52, Evaluated bids 53, and Process response 54. Specific actions for the activity Apply a bid include Receive CFD 55, Prepare distance 56, and Send the distance 57.

In FIGS. 5A and 5B, an instance of a global plan (global workflow case) 58 is created by the mediator agent (step 61) when a job giver agent sends a triggering message to the mediator agent (step 62). The triggering message is the first message produced by the first action of a global plan (in the example interaction, the first message sent by job taker, wherein CFD is a message content).

An example of message content which is sent from a component agent (job giver or job taker agent in FIG. 5A) to the mediator agent is as follows:

```
  (Mediate
  (:sender jobgiver_name@telco.com)
  (:receiver MediatorAgent@telco.com)
  (:ontology “TeamCoordination”)
  (:language “SL0”)
  (:protocol “interaction-mediation”)
  (:content
    (local-workflow-case (uiid “md12121123A”)
      (interaction-plan-id “give-job”)
      (state info : (plan-name “give-job”)(creator “Job Giver's Name”)
(creation-time 27-08-2002))
    (Request
      (:sender jobgiver@telco.com)
      (:language “SL0”)
      (:protocol “FIPA_Request”)
      (:content (action
          (get-distance (task (id “ta1223”)(name “ISDN provision”)
(post-code “IP5 3RE”)))))
    ))
```

More generally, the content of the message according to the invention comprises a predicate representing the local workflow case and an inner-message which needs to be forwarded to other component agents. The mediator agent takes the local workflow case to compose a global workflow case, and forwards the inner-message to the agents which take the role responsible for the next stage of the global interaction plan.

Returning again to FIG. 5B, when a message arrives at the mediator agent 49, the mediator agent checks whether the message is a triggering message or not (step 62). The decision is performed by simply checking whether the message contains a unique interaction identifier number (UIIN) value in its field. The UIIN is supposed to be unique for each global workflow case. If the message is a triggering message, the mediator agent identifies a corresponding global interaction plan by checking the information contained in the message (step 63). For this, the (local-workflow-case (interaction-plan-id “give-job”)) field in the above message content is used. Then, the mediator agent, creates a global workflow case (based on the global interaction plan) (step 64) and assign a UIIN to it (step 65). Next, the mediator agent extracts a local workflow case 59 from the received message and copy it to the created global workflow case (60, step 66).

If the received message is not a triggering message, the mediator agent extracts a local workflow case from the message and copies to the appropriate global workflow case by referring (local-workflow-case (interaction-plan-id “give-job”)) field in the message content. The mediator agent also generates additional information for the global workflow case, for example, such as the actor agent information, created time, and message content etc. The messages from the mediator agent to the component agents use the UIIN from this point.

Referring again to FIGS. 5A and 5B, after recording the initiator and request details on the global workflow case, the mediator agent finds the receivers of the messages based on the global plan description (step 67) and forwards the message to them (step 68). Then, a responding agent executes its local plan and returns a response message to the mediator agent. The response message also contains the local interaction plan workflow case of the respondent agent. The mediator agent then forwards the response message to the initiator agent according to the employed interaction protocol.

Returning briefly now to FIG. 3, the workflow engines of the component agents (both the initiator and respondent agents) sends the local workflow case interaction plan as well as the output of the local interaction plan in the ACL message to the mediator agent via the msg sender 27. The local workflow case 59 is also copied into the global workflow case 60. The point at which a component agent's execution state is logged into permanent storage is determined by when this ACL message is passed from the component agent to the mediator agent. The mediator agent updates the global workflow case (global interaction plan) every time it receives a message from a component agent and logs the latest state of the corresponding global workflow case (global interaction plan). The logged information can be used to recover the state of the mediator agent if it crashes.

Recovery of a Crashed Agent

FIG. 6 shows schematically the interaction protocol for the recovery process according to an embodiment of the invention. In FIG. 6, the protocol begins when a crashed agent (represented by “Attendee” 70 in FIG. 6) re-starts and contacts a mediator agent 71 to subscribe to a mediation service. This is performed by sending a request-subscribe message 72 from the Attendee 70 to the Mediator 71 shown in FIG. 6.

The mediator agent looks up its global workflow case library to check whether the subscribing agent had been involved with any unfinished collaboration. Then, the mediator agent informs the existence of the unfinished collaboration to the subscribed agent (shown as the upper inform message 73 in FIG. 6). The inform message contains the UIID of the collaboration where the agent had been involved. If the re-started agent has been subscribed successfully, the agent registers the mediator agent into its Mediator Directory, which maps a mediation service with a mediator agent. The re-started agent can request the interaction recovery process by sending request message 75 for the state synchronisation process (the request-recover message 75 in FIG. 6) or abort by sending request message 74 which asks the mediator agent to abort the unfinished collaboration. In the latter case, the mediator agent starts the closure process 79 for the unfinished collaboration by sending an abort message to the other participating agents.

If the restarted agent requests recovery, the mediator agent prepares an inform message 76 which contains the local workflow case, which reflects the latest state of the local interaction plan before the previous agent crash (the lower inform message 76 in FIG. 6). The restarted agent, then uses the information to create a local workflow case for the crashed local interaction plan. The received local workflow case is copied into the workflow case base within the workflow engine of the re-started agent. Then, the restarted agent informs the Scheduler of the workflow engine to start scheduling based on the copied state information (the inform-done message 78 in FIG. 6). After then, the workflow case is treated as a normal case, i.e. as any other workflow case within the workflow engine. If there are any failures during the recovery, the restarted agent sends an abort message (request-abort message 77 in FIG. 6) to the mediator agent which aborts the unfinished collaboration by sending an abort message to the other participating agents (the lower request-abort message 77 in FIG. 6). Otherwise, the restarted agent sends an inform message to the mediator agent to signify that it is ready to continue the collaboration.

The recovery process within an agent is shown in more detail in the flow-chart of FIG. 7, which schematically shows steps in the recovery process.

If a component agent has been restarted because of its crash, it receives its local workflow (WF in FIG. 7) case (the latest one before its crash) and buffered messages (messages buffered in the mediator agent during from the crash to the restart of the agent) from the mediator agent (step 81). Then, the component agent checks the validity of the received workflow case (step 82). If the workflow case is valid (step 83), then the component agent copies it to its local workflow case base to make it restarted by its workflow engine (step 84), alternatively the component agent aborts the recovery process (step 89—see below).

If any received buffered messages are exist (step 85), the component agent executes the copied local workflow case by providing the buffered messages as input of the actions in local interaction plan (step 87). If there are any failures during this synchronisation process (step 88), the component agent aborts the recovery process (step 89). Otherwise, the mediator agent sends a success message (step 86 and see also step 78 in FIG. 6) to the mediator agent telling it is ready to continue the old interaction process with other agents (step 86).

Dynamic Delegation of Interaction Role

As the component agents are not closely bound to each other, one component agent can delegate its role to another agent to make interactions which can be continued, even when a component agent cannot recover from critical failure, e.g. due to a power failure on the host device. This functionality is useful where mobility is important as it enables a person operating a mobile device to use multiple devices when executing an application. Such mobile users can delegate the role of an agent on one device to another device via a predefined interaction protocol. This will enable a mobile user to ensure when a device could be expected to crash that the functions performed by an agent running on that device are taken over by one or more agents running on one or more other devices. This is useful particularly for mobile devices, for example, if a battery indicator shows the battery power of the mobile device is failing, or if a network congestion indicator shows that a network connection might be timed out due to high network congestion. It is also possible where power is suddenly lost etc., for reconnection to occur more rapidly as the current state of the collaboration can be found and the collaboration between the initiator and responder agents resumed from where it was left off.

The delegation interaction protocol begins when a component agent sends a request message for a delegation to the mediator agent. The role can be delegated to an existing component agent or a non-existent agent. If a role is delegated to non-existent agent, then the mediator agent keeps all the messages forwarded to the delegating agent and waits until the non-existent agent is launched and tries to subscribe to it. If the new agent subscribes to the mediator agent, then the process for handling the subscription is the same as the recovery process explained in the above section.

The delegation of a role to an existing agent is continued by the mediator agent which forwards the request message to the target agent. The target agent can receive or reject the request, and the local workflow case is transferred to the target agent or aborted according to the response.

A preferred embodiment of the invention provides a workflow system enables mobile business processes to be automated. As mobile workers prefer carrying hand held devices, preferably lightweight devices with little or no local storage facilities, the workflow client system is particularly useful in ensuring that recovery is possible in the event that a connection is lost by the mobile device. In particular, one embodiment of the invention is of use when multiple distributed workers co-ordinate their work via predefined interaction protocols such as “Auction” or “Contract-Net”.

Another embodiment of this invention enables a mobile user to dynamically recover information so that it is possible to switch operation from one mobile device to another device. The invention is equally useful when an operator of one device wishes to interrupt the power supply to another device, for example due to battery problems or other causes of inoperability in the middle of co-ordination with other workers.

This enables a system to be highly reliable and robust even under inferior environmental conditions such as unstable network connection and low computing power.

This invention is a very generic technology which can be applied to any kind of multi-agent systems where a client agent can change its local device dynamically, dependent on the prevailing circumstances. For example, if a user is working in one office and interacting with colleagues, then it is possible to re-locate to another site or building and continue the interaction with colleagues, retaining the latest interaction state when the interaction resumes.

This is shown in FIGS. 8A and 8B. In FIG. 8A, a simple interaction between an initiator agent A and a respondent agent C via a mediator agent is shown by way of contrast. In FIG. 8A, the mediator maintains the global interaction plan status information of both A and C, and A maintains a local interaction plan which includes information forwarded by the mediator agent on its interaction status and the status of respondent agent C. Similarly, respondent agent C maintains a local interaction plan which includes its status information and details of A's status information where this has been forwarded by the mediator agent. In the event that A loses its connection with the mediator agent, the mediator agent is able to provide details of the global interaction plan to a delegate agent (not shown) which takes over A's role in the interaction. This global interaction plan contains sufficient information for the delegate agent to continue to interact with C as though the connection with A had not been lost in so far as the delegate agent will be aware of the interaction state of C at the time the connection was lost to the same extent that A was aware of this information.

In FIG. 8B, another agent, B, initiates communication with C via the mediator agent. If the application requires A to be aware of the state of B's interaction with C, for example, if an on-line real-time auction is being conducted, the mediator agent must ensure that the global interaction plan reflects this. This ensures that if A loses its connection with C, the mediator agent is able to ensure that the global interaction plan enables the delegate agent to recover the state of the interaction as it has since evolved following A losing its connection, so that it updates the delegates local interaction plan with the latest information on the status of the interaction between C and B, and so ensures that A resumes its interaction with an awareness of this state.

It will be appreciated by those skilled in the art that many features of the invention can be implemented in either software and/or hardware and that the spirit of the invention is intended to cover embodiments in any combination of software and/or hardware as appropriate.

1. A method of recovering the status of a collaboration between a plurality of component agents in a multi-agent systems architecture, the method comprising:
processing collaboration information forwarded by a mediator agent for each component agent;
maintaining a collaboration processing status information record derived from the collaboration information provided by each collaborating agent to the mediator agent; and
in the event that a device which affects the collaboration suffers an event which causes one or more component agents to lose its collaboration status, recovering the collaboration status using one or more of said collaboration processing status information records.

2. A method as claimed in claim 1, wherein the mediator agent is arranged to register its mediation service with an administration agent of any multi-agent platform.

3. A method as claimed in claim 2, wherein said component agents subscribe to the mediation service prior to said step of recovering the collaboration status.

4. A method as claimed in claim 1, wherein if a first component agent delegates its role to at least one other delegate component agent, the mediator agent maintains status information on the role of each at least one other delegate component agent.

5. A method as claimed in claim 1, wherein the mediator agent maintains status information on the role of all delegate agents.

6. A method as claimed in claim 1, wherein the collaboration between said plurality of agents is defined by an interaction plan comprising a global plan and a local plan, wherein the global plan specifies overall interaction steps for each component agent participating in the collaboration and the local plan specifies each collaboration activity for each participating component agent.

7. A method as claimed in claim 1, wherein said collaboration information forwarded to the mediator agent comprises the execution state of a component agent's local plan.

8. A method as claimed in claim 7, wherein the component agent does not store an execution state of that component agent's local plan instance in permanent storage.

9. A method of delegating between a first component agent arranged to perform a predetermined role and another agent in a multi-agent architecture, the component agent and the other agent arranged to communicate via a mediator agent, the method comprising the steps of:
sending a request message from the first component agent to a mediator agent for delegation to another agent;
forwarding the delegation request message to the other agent by the mediator agent;
receiving the delegation request at the other agent;
processing the delegation request and providing an indication to the mediator agent that the delegation request has been accepted;
transferring from the mediator agent, information comprising a local workflow case to the other agent from the first component agent.

10. A method as claimed in claim 9, wherein prior to said step of forwarding the delegation request, the method further includes the steps of:
retaining all messages at the mediator agent until the other agent is launched; and
subscribing the mediator agent to the other agent.

11. Apparatus arranged to recover the status of a collaboration between a plurality of component agents in a multi-agent architecture, the apparatus comprising:
at least one processor arranged to process collaboration information forwarded by a mediator agent for each component agent;
storage means arranged to maintain a collaboration processing status information record derived from the collaboration information provided by each collaborating agent to the mediator agent; and
in the event that a device which affects the collaboration suffers an event which causes one or more component agents to lose its collaboration status, means to provide information derived from said one or more of said collaboration processing status information records in a form suitable for updating each component agent affected by the event with current collaboration status information.

12. A mediator agent arranged to provide a mediation service to recover the status of a collaboration between a plurality of component agents in a multi-agent systems architecture, the mediator agent comprising:
means to receive and store collaboration information provided by each component agent;
means to update the collaboration information to generate at least one processing status information record; and
in the event that a device which affects the collaboration suffers an event which causes one or more component agents to lose its collaboration status, recovering the collaboration status using one or more of said collaboration processing status information records.

13. A component agent arranged to provide recovery information to a mediator agent, the component agent having means to forward information indicating its local interaction plan state to a mediator agent, the mediator agent as claimed in claim 12.

14. A component agent arranged to provide recovery information to a mediator agent, the component agent having means to store information indicating its local interaction plan state and to forward information on said interaction state to a mediator agent.

15. A computer program product comprising a suite of one or more programs arranged to perform a method according to claim 1.

16. A computer program product comprising a component in an on-line auction application.

17. A computer program product comprising a component in an on-line gambling application.

18. A network comprising one or more devices arranged to implement the method of claim 1.

19. A network comprising a plurality of apparatus as claimed in claim 11.

20. A multi-agent architecture comprising a plurality of component agents and a mediator agent, the mediator agent arranged to mediate between a plurality of said component agents performing a collaboration, the architecture being arranged to perform steps in the method according to claim 1.

21. A signal comprising a service subscription message arranged to subscribe a component message to a mediator service supported by a mediator agent, the mediation service comprising a method delegating between a first component agent arranged to perform a predetermined role and another agent in a multi-agent architecture as claimed in claim 10.

22. A workflow engine architecture arranged to be embedded into a component agent, the workflow engine architecture comprising:
a scheduler;
a task manager;
a state manager;
a tool library; and
a workflow case base.

23. A method of restarting a local workflow case dynamically given by a mediator agent, the method comprising:
verifying the validity of received workflow case from a mediator agent;
storing the valid workflow case into local workflow case base; and
synchronising the local workflow case with global workflow case of the mediator agent by executing the buffered messages from a mediator agent.
